(19) United States
(12) Patent Application Publication
(10) Pub. No.: US 2007/0049449 A1
(43) Pub. Date: Mar. 1, 2007

(54) Power transfer device

(76) Inventor: James Klassen, Langley (CA)

Correspondence Address: DYKAS, SHAVER & NIPPER, LLP, P.O. BOX 877, BOISE, ID, 83701-0877, US

(21) Appl. No.: 11/384,003

(22) Filed: Mar. 17, 2006

Related U.S. Application Data
(60) Provisional application No. 60/594,202, filed on Mar. 18, 2005.
(60) Provisional application No. 60/597,596, filed on Dec. 12, 2005.

(51) Int. Cl. F16H 13/08

(52) U.S. Cl. 475/196

(57) ABSTRACT

A power transfer device uses the differential ball principle or friction gear with friction reducing features for a given output torque capacity. The friction gear may be used in high output torque applications with an acceptably low torque requirement at the input. The power transfer device incorporates a two stage differential ball device or friction gear. If a second stage is used as a reduction stage, then a pre-reduction stage may be added. The device also includes an integrated stabilizing thrust bearing, high ball count, and material selection for reduced friction.

### CROSS-REFERENCE TO RELATED APPLICATIONS

This application claims the benefit under 35 USC 119(e) of provisional patent application No. 60/______ filed Mar. 18, 2006 and No. 60/______ filed December X, 2005.

### BACKGROUND

A power transfer device that uses the differential ball drive principle as shown in for example U.S. Pat. Nos. 3,688,600 and 1,995,689 is able to achieve high reduction ratios in a simple, low cost, light weight device. However, these devices, also known as friction gears, have not found widespread use in industry. It is the belief of the inventor that this is primarily due to low torque output capacity for a given torque input. It is possible to increase torque output capacity with a differential ball device by using a high preload force, but this increases the friction of the device, resulting in a high input torque requirement, to a point where the light weight, simplicity and low cost benefits of the device are overcome by the need for a higher cost, heavier drive motor.

The amount of torque which can be transmitted by a given differential ball assembly, is dependent on the axial preload force which is applied to the speed change races and ball members. The differential ball principle, with common bearing materials such as steel races and steel ball elements, is capable of achieving low torque movement with reasonably low friction if axial preload is kept to a minimum. However, as the preload on the assembly is increased (in order to increase the torque output) the friction of the system increases at a greater rate than the torque output capacity. A reason for the dramatic increase in friction is the increased deformation of the ball elements and races with higher pre-load. The increased deformation causes a swirling of the contact between ball elements and the races, which causes a decrease in the traction coefficient between ball elements. Increasing the preload therefore causes the friction to increase at a greater rate than the torque output.

Steep contact angles in a differential ball speed change device create much higher friction than a conventional angular contact bearing of the same diameter with the same preload. Friction is high enough that the torque required at the differential ball speed change device input is at least an order of magnitude higher than the torque required to turn a comparable angular contact bearing with the same preload.

Thus, the torque required at the input is a significantly higher percentage of the output torque than the speed of the input is a percentage of the speed of the output. For example, if the speed ratio is 100:1, the torque ratio might only be 20:1. This means that to achieve a torque output of 200 ft-lb, the input torque for a single stage would need to be 10 ft-lb. At lower output torque, the differential ball drive is quite efficient, but as the torque increases, the efficiency decreases.

This characteristic of the friction increasing at a greater rate than the torque output capacity is believed by the inventor to be a significant reason why the differential ball principle has not become widely used in industry.

### SUMMARY

According to an aspect of an embodiment of the invention there is provided a power transfer device operating according to the differential ball principle or friction gear that has friction reducing features. These features enable the power transfer device to be used in high output torque applications with an acceptably low torque requirement at the input. An object of an embodiment of the present invention therefore is to increase the torque output capacity of the differential ball principle while at the same time decreasing the torque input requirement.

In one embodiment of the invention, there is provided a power transfer device that incorporates a two stage differential ball device or friction gear. Surprisingly, although a single stage friction gear device is capable of providing high gear ratios, for a given speed reduction and torque output, a two stage friction gear requires lower torque input as compared with a single stage friction gear. The first stage can be more lightly preloaded and so it can achieve higher efficiency and thereby reduce input friction further. The device may operate as a speed reducer or speed enhancer.

In an embodiment of the invention, a third stage friction gear may be added to bring the friction effect down even further, to provide a very high torque output, even though there is a lot of friction inherent in the final reduction stage.

In further embodiments of the invention, there are provided devices that increase torque capacity and/or decrease input friction of a differential ball drive system by several different means such as: low race angles relative to the ball spinning axis, materials with higher rigidity or hardness, materials with higher friction coefficients, convex races, low or no lubrication on output and use of traction fluids.

In accordance with another embodiment of the present invention, the differential ball device with reduced friction features may be used in precision rotary applications. In addition, a further embodiment of the invention is the use of an integrated thrust bearing, which provides preload for the friction gear stages and also provides axial and radial support for the output of the power transfer device. A center through-hole is also provided for wires etc. for robotics applications and for applications such as telescope positioning where a large diameter, low profile bearing/rotary actuator would be an advantage.

In a further embodiment of the invention, there is provided a differential ball device or friction gear with an off-center pre-reduction drive configuration such as for an azimuth or elevation drive on a telescope. A conventional drive could be the pre-reduction drive for a hollow shaft speed reducer of the present invention, in which the conventional reducer turns a pinion gear driving a ring gear attached to the input of the friction gear. According to a further embodiment of the invention, a differential ball device may be used as the pre-reduction drive for a conventionally geared azimuth or elevation drive in which the device drives a small pinion gear which meshes with a large internal or external ring gear or rack.

According to a further embodiment of the invention, a differential ball device may include a gear ratio sensor, which may be a position sensing device on the output (such as an encoder or resolver), or on the output and the input, with the input being continuously calibrated by the output. Other devices such as torque sensors may be used to predict the ratio output at a given load, acceleration, speed, etc based on recorded data (either at the factory or from the use of the actual device—ie the system learns). Calibrating the input (high speed) encoder with the output encoder is important for ultra high resolution requirements because the higher speed of the input allows much finer resolution than the low speed output. According to a further embodiment of the invention, a differential ball device uses more than 6 ball elements distributed around the races to reduce the output deformation. These and other aspects of the invention are set out in the claims, which are incorporated here by reference.

### BRIEF DESCRIPTION OF THE FIGURES

Embodiments of the invention will now be described with reference to the figures, in which like reference characters denote like elements, by way of example, and in which:

FIG. 1 is a sectioned perspective view of a two stage power transfer device according to an embodiment of the invention;

FIG. 2 is a cross-section of a single stage friction gear according to an embodiment of the invention, which may be used as the first stage of the embodiment of FIG. 1, showing contacts of the ball elements with the races;

FIG. 3 is a cross-section of a single stage friction gear according to an embodiment of the invention, which may be used as the second stage of the embodiment of FIG. 1, showing contacts of the ball elements with the races;

FIG. 4 illustrates a convex race according to an embodiment of the invention;

FIG. 5 is a cross-section of a two stage friction gear according to an embodiment of the invention, showing a device with an inner first stage drive;

FIGS. 6-10 are sections through exemplary two stage friction gears showing various combinations of inner and outer drives and output;

FIG. 11 is a section through an embodiment of a single stage friction gear according to the invention;

FIG. 11a is a section through an embodiment of a single stage friction gear showing a thrust bearing on the output;

FIG. 12 shows a further embodiment of a single stage friction gear;

FIG. 13 is a section through another embodiment of a two stage friction gear showing convex races; and

FIG. 14 is a perspective view of a drive configuration on the inside diameter of a device.

### DETAILED DESCRIPTION

In the claims, the word “comprising” is used in its inclusive sense and does not exclude other elements being present. The indefinite article “a” before a claim feature does not exclude more than one of the feature being present. A ball element is a ball that is generally spherical but may be somewhat oblate or an ellipsoid. A contact between a ball element and race is an area at the interface between a ball element and a race. The orientation of a contact for determining its angular location may be considered either as the tangent to the ball element at the center of the contact or a chord connecting exterior edges of the contact. An example is when a ball rolls along a flat surface. With high angle contacts, such as may occur when a ball rolls along a V-shaped race, the ball tends to swirl along the race, with the contact varying on the race across a contact patch between a maximum and minimum. The depth of a contact is the difference between the maximum and minimum distance of each contact from the rotation axis of the ball bearing. As a ball rolls along a low angle contact of a race, the contact depth is minimized, and is at a minimum when the ball rolls along a flat surface. This corresponds to a zero contact angle. The term contact between two objects means sufficiently close to have a deformation effect of the objects on each other, and includes the situations when there is full contact, contact with a boundary fluid, and contact through lubricant. Thus, on a high speed lubricated contact between two objects, high viscosity of the lubricant will transmit deformation forces and the two objects will thus be in contact.

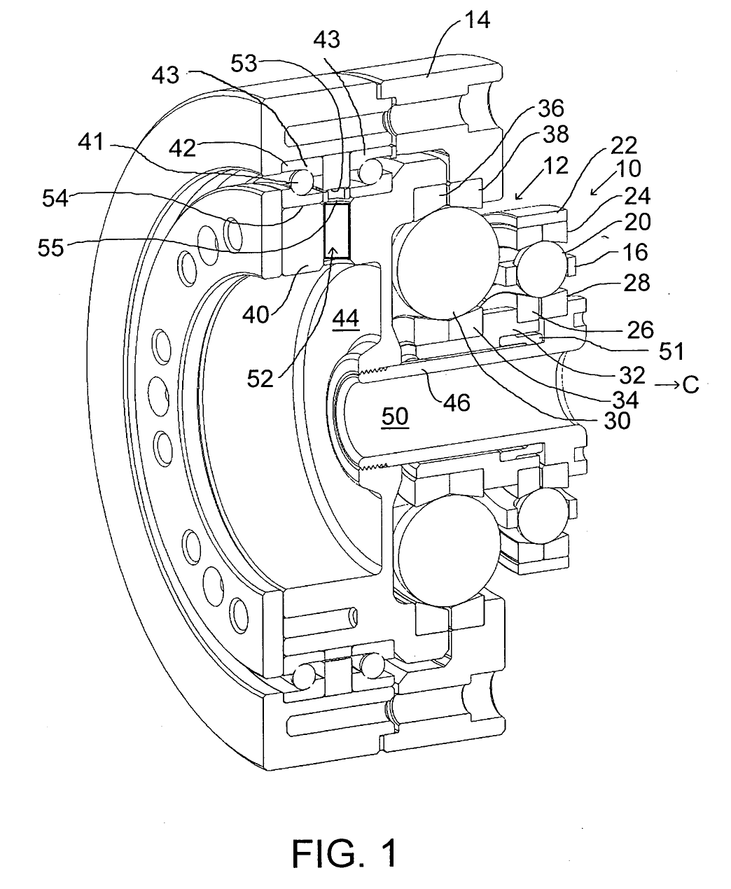

A two stage power transfer device is shown in FIG. 1 with on the right side a first stage friction gear 10 and on the left side a second stage friction gear 12 supported by a housing 14. The housing 14 provides axial and radial stability to the friction gear components and may be made of several parts depending on the configuration of the friction gears. Multiple stages as shown in FIG. 1 with two stages may be used, though there could be three or more, and provide not only for increased gear ratio, but also to allow high preload on the output stage and low preload on input. Multiple stages solves the torque input requirement problem by allowing higher friction (and therefore, higher output torque) in the final stage while allowing lower input torque in the pre-reduction stage/s. Basically, the input torque requirement is reduced by a greater rate in each preliminary stage than the output torque requirement. The races may be pressed into their respective housings. The rotation establishing races or any of the races may be configured as a single or multiple piece device. In an embodiment of the invention, a rotary precision of 0.1 arc seconds or better has been obtained.

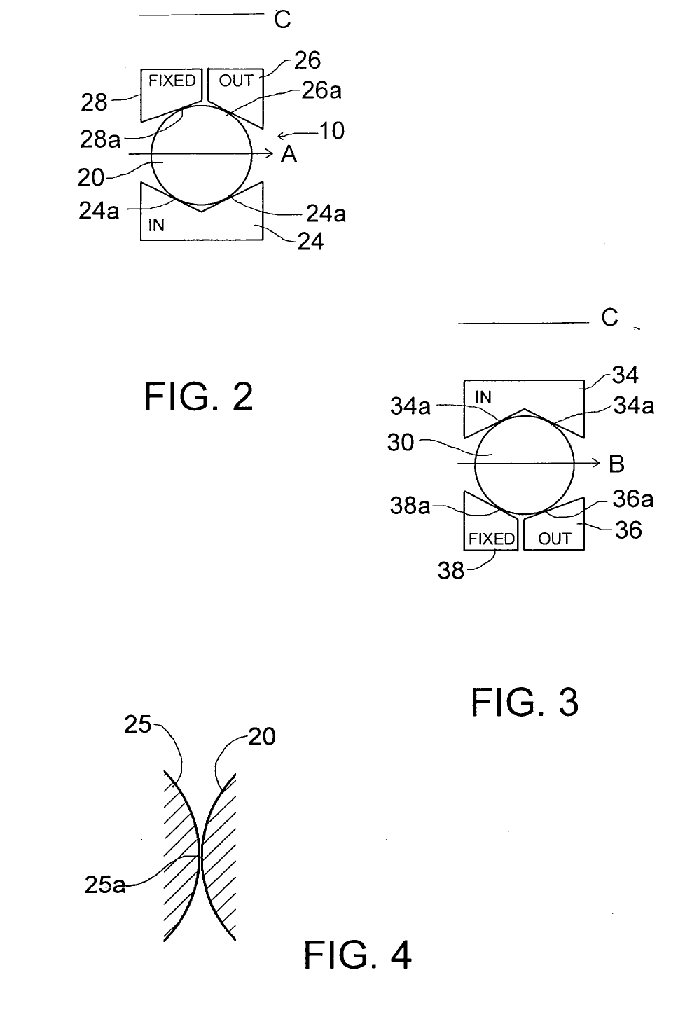

In the friction gear 10, a cage 16 holds a set of ball elements 20. FIG. 2 illustrates the configuration of the friction gear 10 as a single stage equivalent, showing a section of one of the ball elements supported within the races 24, 26 and 28, also shown in section. Centerline C refers to the centerline of the friction gear, about which the races form an annulus. The ball elements 20 are in contact with the drive race 24 at a set of drive race contacts 24a, with the driven race 26 at a set of driven race contacts 26a, and with the reference race 28 at a set of reference race contacts 28a. The races 24, 26 and 28 are annular and in one embodiment there are at least seven ball elements 20 distributed around the races. The drive race 24 has a pair of contacts 24a on each ball 20 and so establishes the rotational axis A of the ball elements 20. The reference race contacts 28a are on an opposite side of the ball elements to the drive race 24. The driven race contacts 26a lie on the ball elements 20 between the drive race contacts 24a and the reference race contacts 28a either on one side of the ball elements 20 or the other. That is, as shown in FIG. 2, the contacts 24a, 26a and 28a on a particular ball bearing 20 lie on a great circle, and the contact 26a lies on the great circle, on either side of the fixed contact 28a, between the contacts 26a and the fixed contact 28a.

The reference race 28 may be considered fixed, at least in relation to the drive race 24 and driven race 26, and the drive race 24 and driven race 26 move in relation to the reference race 28 at relative speeds in proportion to the respective contact distances of the contact points 24a and 26a from the reference race measured at right angles to the rotational axis A. Hence, if the driven race contact 26a is close to the reference race contact 28a, and the drive race contacts 24a are on the opposite side of the ball from the driven race contact 26a, a high gear ratio of N:1 may be obtained where N may be in the order of 50. The gear 10 may be a speed reducer or increaser, so the ratio may be N:1 or 1:N. The gear 10 is shown as a speed reducer with the drive race 24 being connected to an input 22, but a gear with the configuration of the gear 10 as shown in FIG. 2 may also be operated with the drive race being the driven race and the driven races being the drive race to achieve a speed increaser, such as but not limited to high speed machining applications or wind power generators.

As shown in FIG. 1, the driven race 26 of the gear 10 is connected to an output 32, which forms the input of gear 12. Output 32 is connected to a drive race 34 which is in contact with a set of ball elements 30 of the gear 12. FIG. 3 illustrates the configuration of the friction gear 12 as a single stage equivalent, showing a section of one of the ball elements 30 supported within the races 34, 36 and 38, also shown in section. Centerline C refers to the centerline of the friction gear, about which the races form an annulus. The ball elements 30 are in contact with the drive race 34 at a set of drive race contacts 34a, with the driven race 36 at a set of driven race contacts 36a, and with the reference race 38 at a set of reference race contacts 38a. The races 34, 36 and 38 are annular and in one embodiment there are at least seven ball elements 30 distributed around the races. The drive race 34 has a pair of contacts 34a on each ball 30 and so establishes the rotational axis B of the ball elements 30. The reference race contacts 38a are on an opposite side of the ball elements to the drive race 34. The driven race contacts 36a lie on the ball elements 30 between the drive race contacts 34a and the reference race contacts 38a either on one side of the ball elements 30 or the other. That is, as shown in FIG. 3, the contacts 34a, 36a and 38a on a particular ball bearing 30 lie on a great circle, and the contact 36a lies on the great circle, on either side of the fixed contact 38a, between the contacts 36a and the fixed contact 38a.

The driven race 36 is connected to an output 40. The output 40 is stabilized axially and radially by a thrust bearing 42 secured within the housing 14. The thrust bearing 42, for example a duplex set angular contact bearing, with two separators, also functions to secure the output 40 for rotation within the housing 14. The thrust bearing 42 is formed from two sets of bearings 41 secured between inner and outer races 43 and 54. The output 40 is also connected to the reference race 28 through a diaphragm spring 44, which is threaded to an extension member 46 that holds the reference race 28. The output 32 may or may not be centered by a bushing 51 on extension member 46. The first stage 10 may be provided with its own thrust bearing, or, as in the embodiment shown, the second stage 12 may act as a thrust bearing for the first stage 10. The output of the second stage friction gear 12 in one embodiment is provided with a position encoder 52. Ball elements 30 may also be positioned by a cage to provide spacing between the balls 30.

In some embodiments, referring to FIGS. 2 and 3, the contacts of least one race, and in one embodiment all of the races 24, 26, 28, 34, 36 and 38 make an angle to the rotational axes of the respective contacted ball elements that is less than 20 degrees. The importance of low angles is explained as follows. A differential ball speed change device uses axial preload to provide the necessary traction between the ball elements 20, 30 and the races. Conventional bearings which are axially loaded, such as an angular contact bearing, use a steeper race contact angle to increase the axial load capacity of the bearing. To increase the torque output of a differential ball speed change device, it is necessary to increase the axial preload on the ball elements and races. It is, therefore, intuitive to use a steeper race contact angle, similar to an angular contact thrust bearing, to increase the axial preload capacity of the assembly. In an embodiment of the invention, however, an increase of output torque capacity may be made by increasing the contact pressure of the ball elements to the races and at the same time decreasing the axial preload requirement, which is achieved by decreasing the angle of the races. Lower race contact angles allow the angle of the contact patches to be closer to parallel with the rotational axis of the ball elements, allowing reduced contact depth and therefore lower swirling/sliding motion at the contact points and a higher coefficient of traction. The coefficient of traction increases with decreased swirl. A higher coefficient of traction allows a lower preload force allowing a lower input torque for a given output torque.

If contact angles of the reference and driven races are too close to each other, the contact patches of the reference and driven races will overlap (on a line on a plane which passes though all four contact patches, this line being parallel to a line through the two input race contact patches). The speed change ratio can become unstable in this case. Race contact angles in one embodiment for a speed change ratio between 50:1 and 300:1 (depending on the size of the ball elements relative to the diameter of the races) are 20 and 10 degrees for the reference and driven races. The fixed or output race can be either angle.

In one embodiment, the angle of the input races are within the range of the fixed and output race contact angles. A consideration in some embodiments is that if the input race angles are too low, the input contact patches will be too close together and the “vertical torque” on the ball element (around an axis on the plane that passes through all four contact patches, the axis being perpendicular to the intended ball rotational axis) will be too high and the ball will be able to spin “vertically”, reducing the output torque. Conversely, if the input race contact angles are too high, the contact depth will be higher than necessary and the friction will be higher than necessary. While a low contact angle of 20 degrees may be used in one embodiment, in other embodiments one, some or all of the races have contact angles less than or equal to 27.5 degrees, 25 degrees or 22.5 degrees. Put another way, the sum of the contact angles in some embodiments may be less than 120 degrees, 110 degrees, 100 degrees, 90 degrees or 80 degrees. The low contact angles of the races with the bearings are also useful in a single stage friction gear as illustrated in FIG. 2, 3 or 11a, for example. The contact angles of each race may be different, in which case the rotational axis A or B of the balls may not coincide with the central rotational axis C of the power transfer device. The rotational axes of each race should coincide with the central axis C of the power transfer device (seen in FIGS. 1, 2, 3, and 5-10).

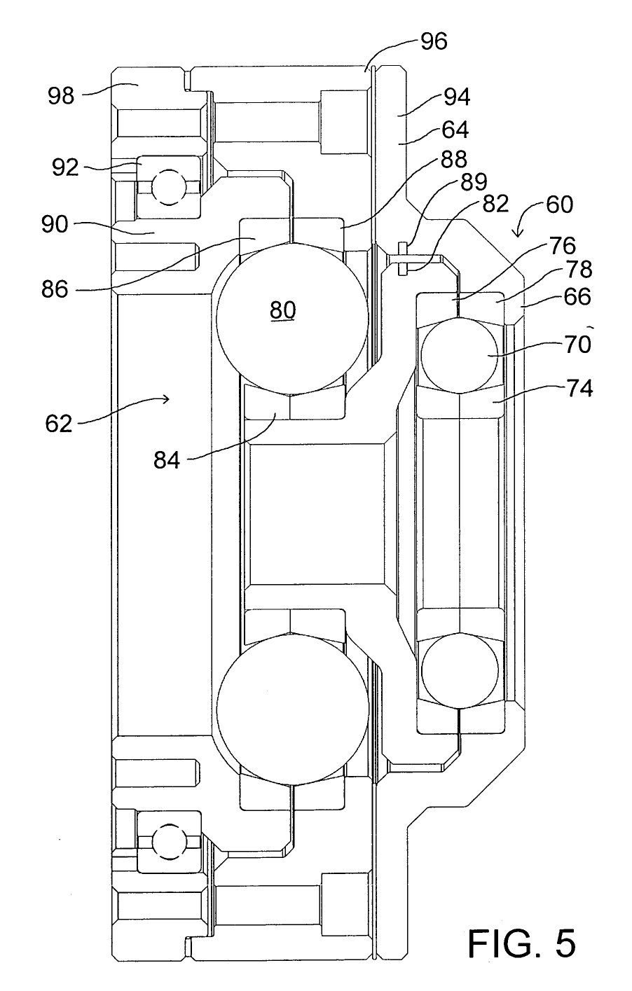

In FIGS. 1, 2 and 3, the faces of the races in contact with the ball elements are shown as conical. Advantages may also be obtained if the faces of any, and in some embodiments all, of the races are convex at their contacts with the ball elements, as shown in FIG. 4, where race 25, which could be any or all of the races in FIG. 1, has a convex face that meets ball 20 at a contact 25a. Use of convex races is especially useful on steeper races which will experience lower contact pressure as a result of preload due to less mechanical advantage of the ball elements against the higher angle races. These steeper races can therefore tolerate a smaller contact patch. A convex race provides a smaller contact patch, resulting in the same PSI contact force as the conical, or less convex, or concave races on lower angle races.

The power transfer device shown in FIG. 1 is provided with a central opening 50 that passes through the drive races, reference races and driven races. The central opening 50 is useful in single or multiple stage power transfer devices.

Advantages may also be obtained by clever choice of materials for the components of the power transfer device of FIG. 1, or a single stage device such as shown in FIG. 2, 3 or 11. In some embodiments, at least one, and in some embodiments each of the drive races 24, 34, driven races 26, 36 and reference races 28, 38 has a coefficient of static friction with the ball elements 20, 30 respectively when lubricated that is higher than 0.11, which is the coefficient of static friction for lubricated hard steel on hard steel. An extremely hard material such as tungsten carbide has a coefficient of static friction of 0.2. For this reason, it is not intuitive to use tungsten carbide bearings to reduce the friction of a lubricated ball bearing device. Conversely, it is reasonable to assume that the higher coefficient of friction of this material would increase the friction, and therefore the input torque, of a differential ball device. However, it has been found by the inventor that a high friction coefficient material such as, but not limited to, tungsten carbide, used with a differential ball speed change device, does not require as high a preload force to achieve the same output torque as steel ball elements and races. This reduced preload force has a further benefit of reducing the contact patch size and therefore the amount of swirling/sliding motion. Reducing the swirling/sliding motion increases the coefficient of traction between the materials so a further decrease in preload is possible for a given output torque. Reduced preload, along with the above mentioned benefits, results in a significantly higher output torque for a given input torque, or lower input torque for a given output torque.

Other high friction coefficient materials include, but are not limited to, nickel, various ceramics, or carbides such as silicon carbide, or cerbide, a ceramic carbide material, and the high friction coefficient material may be a coating. Higher friction materials are not usually associated with lower friction bearing operation, but in this case the reduced preload requirement of higher friction materials reduces the contact size, thus reducing the swirling contact, and therefore increasing the traction coefficient of each contact patch allowing high output torque with low input torque. The materials for the races and bearings should be chosen to avoid adhesion of the parts to each other.

In some embodiments, a single or multiple stage friction gear has at least one of the drive races, driven races, reference races and ball members with a stiffness greater than 190 GPa, which corresponds to the stiffness of conventional bearing steel, and in some embodiments, greater than 250 GPa, such as silicon nitride with a stiffness of 320 GPa . . . . Ceramic bearings such as silicon nitride bearings have a significantly lower coefficient of friction than commonly used steel bearings. For this reason, silicon nitride bearings are often used to reduce the rolling friction of conventional bearings. It is reasonable to assume that the lower coefficient of friction of this material would reduce the friction, and therefore the output torque capacity, of a differential ball device. However, it has been found by the inventor that the smaller contact patch of the silicon nitride ball elements results in significantly lower swirling/sliding motion as compared to steel ball elements on steel races. This reduction in the swirling/sliding motion results in a more favorable traction characteristic as compared to steel resulting in higher output torque for a given input torque, or lower input torque for a given output torque. A ball element or races may be case hardened.

For application in magnetic resonance imaging equipment, the power transfer device may be made, at least in part of materials that are MRI compatible, that is, non-magnetic materials, or materials that are MRI invisible, that is, non-conducting materials, such as but not limited to ceramics.

Slowly rotating single stage friction gears or slow rotation second stages of multiple stage friction gears may allow the ball elements such as ball elements 30 to rotate slowly enough to maintain ball element to race contact at all times with a lubricant. In some embodiments, a single stage or final stage of a multiple stage friction gear may rotate slowly enough that lubrication will not be necessary in certain applications with the correct material selection, for example silicon nitride balls with silicon nitride or steel races. When lubrication is used, a high traction lubrication may be used such as mineral oil or Santotrak™ traction oil to assist in maintaining traction. A low viscosity fluid may be used to prevent lift off of the races from the bearings.

In a gear reducer, the final stage needs the highest torque and operates at low speed and can therefore tolerate dry operation in some applications. The input ball elements and races in a gear reducer are higher speed and have a lower torque requirement and therefore will likely require lubricant in most applications but will not be as adversely affected by the reduction in traction because the preliminary stage/s do not require as high of a torque output.

The input 22 of the first stage friction gear 10 or a single stage may be driven by any means, and in some embodiments by an electric motor, for example a high rotational accuracy electric motor. The power transfer device whether with multiple or single stages may be used as mini, micro or nano speed change devices. The thrust bearings 42 may also be used in a single stage device 12 (ie, as if the first stage friction gear 10 was replaced by an input drive motor such as an electrical motor) and may be of any type or combination of types that provide radial, axial, and “wobble” positioning. In a two stage device, the first stage requires much lower axial load due to the lower torque output requirement, and so the second stage may be used as the axial load member for the first stage. The added thrust load due to the first stage may be accommodated because this thrust load does not add significantly to the thrust load on the output balls or races. In a three stage device, the input stage may be used as a pre-load bearing for the first stage or be provided with its own pre-load bearing.

A single or multiple stage power transfer device may have inner or outer drive configurations for the input and/or the output. The device of FIG. 1 has an outer drive configuration for the input stage. The device of FIG. 5 has an inner drive configuration for the input with on the right side a first stage friction gear 60 and on the left side a second stage friction gear 62 supported by a housing 94. The housing 94 provides axial and radial stability to the friction gear components and may be made of several parts depending on the configuration of the friction gears. As with FIG. 1, the input torque requirement is reduced by a greater rate in each preliminary stage than the output torque requirement.

In FIG. 5, in the friction gear 60, a member 66, which is secured to housing 94, holds a set of ball elements 70 held by a drive race 74, driven race 76 and reference race 78, also shown in section. The ball elements 70 are in contact with the races 74, 76 and 78 in like manner and with like result to the races of FIG. 1. However, in this case, the drive race 74 is on the inside of the driven race 76 and reference race 78, which are radially outward from the drive race 74. As shown in FIG. 5, the driven race 76 of the gear 60 is connected to an output 82, which forms the input of gear 62. Gear 62 operates in like manner to gear 12. Output 82 is connected to a drive race 84 which is in contact with a set of ball elements 80 of the gear 12. The ball elements 80 are supported by and in contact with the drive race 84, driven race 86 and reference race 88, also shown in section. As with the configuration of FIG. 5, the driven race 86 is connected to an output 90. The output 90 is stabilized axially and radially by a thrust bearing 92 secured within the housing 94. In this case, the output 90 is not connected to the reference race 74. However, the reference race 74 is connected via housing portions 94 and 96 to the housing 98 of the thrust bearing 92. Although the device is shown with rotation of the drive and driven races in the same direction, output from any of the stages can be in the same direction or in reverse to the input of that stage.

An inner drive (sun input) such as is shown in FIG. 5 for the two stage embodiment results in a higher ratio. The outer drive embodiment of FIG. 1 with annular input allows for a simpler construction, and may be suitable for hand dial activation or other outer drive systems such as a hollow shaft motor, or air turbine drive. The outer drive input has the added benefit of an integrated low speed bore member to protect wires and other objects in the bore from spinning parts. The second stage of a two stage embodiment may be situated in the same plane as the first stage or arranged side by side as in FIG. 1, depending on space requirements. A three stage embodiment could also have the first input stage on the same side of the device as the final output stage by driving the second stage through the central opening of the third stage.

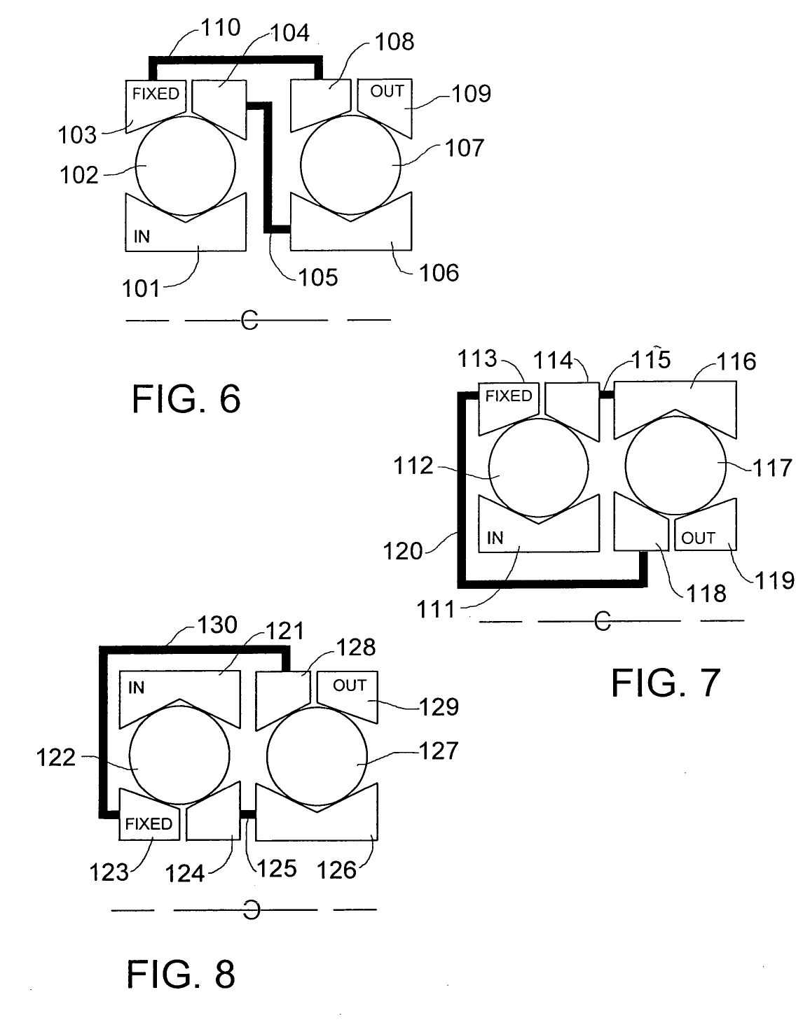

In each of FIGS. 6-10, the left side shows a first stage and the right side shows a second stage of a two stage power transfer device. In FIG. 6, left side, an inner drive race 101 drives a set of balls 102 that roll on fixed race 103 and drive driven race 104. Driven race 104 is fixed to drive race 106 of the second stage by coupler 105. Drive race 106 drives a set of balls 107 that roll on fixed race 108 and drive driven race 109 to form an outer output. Fixed race 103 is connected to fixed race 108 by coupler 110. In FIG. 7, left side, an inner drive race 111 drives a set of balls 112 that roll on fixed race 113 and drive driven race 114. Driven race 114 is fixed to drive race 116 of the second stage by coupler 115. Drive race 116 drives a set of balls 117 that roll on fixed race 118 and drive driven race 119 to form an inner output. Fixed race 113 is connected to fixed race 118 by coupler 120.

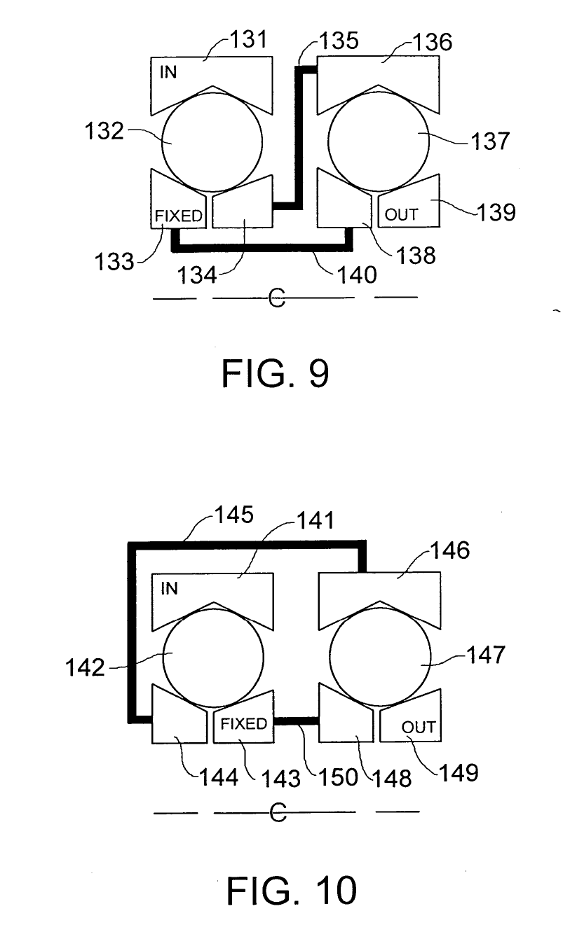

In FIG. 8, left side, an outer drive race 121 drives a set of balls 122 that roll on fixed race 123 and drive driven race 124. Driven race 124 is fixed to drive race 126 of the second stage by coupler 125. Drive race 126 drives a set of balls 127 that roll on fixed race 128 and drive driven race 129 to form an outer output. Fixed race 123 is connected to fixed race 128 by coupler 130. In FIG. 9, left side, an outer drive race 131 drives a set of balls 132 that roll on fixed race 133 and drive driven race 134. Driven race 134 is fixed to drive race 136 of the second stage by coupler 135. Drive race 136 drives a set of balls 137 that roll on fixed race 138 and drive driven race 139 to form an inner output. Fixed race 133 is connected to fixed race 137 by coupler 140. In FIG. 10, left side, an outer drive race 141 drives a set of balls 142 that roll on fixed race 143 and drive driven race 144. Driven race 144 is fixed to drive race 146 of the second stage by coupler 145. Drive race 146 drives a set of balls 147 that roll on fixed race 148 and drive driven race 149 to form an inner output. Fixed race 143 is connected to fixed race 148 by coupler 150.

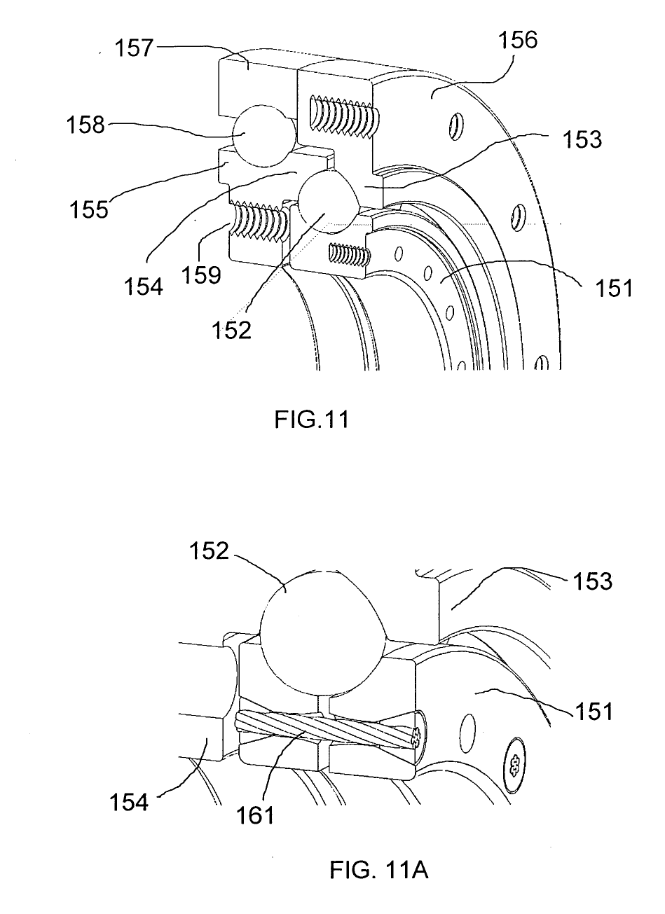

A single stage device is shown in FIG. 11. In FIG. 11, an inner drive race 151 drives a set of balls 152 that roll on fixed race 153 and drive driven race 154. Driven race 154 is connected to an output 155. Fixed race 153 forms part of a housing 156 that is secured by any suitable means to one side 157 of a thrust bearing 158, the other side of which is the output 155. Drive race 151 is formed as a pair of races. Thrust bearing 158 contacts the member 157 on two points, and the member 155 on two points to provide axial and radial stability for the output 155 and to provide a thrust bearing for this single stage device. Referring to FIG. 11a, there is shown a single stage device in which the components are the same as those shown in FIG. 11, except the two races forming in the inner drive race 151 are coupled axially by a tension device 161. The tension device 161, which may be a cable or other tension device will increase traction force when increase torque is applied to the drive race 151 and/or driven race 154. This device, which is described as a speed reducer, may be operated as a speed increaser, in which the driven race 154 is the input and drive race 151 is the output. In some embodiments, such as the device of FIG. 11, the tension device 161 is omitted.

As shown in FIG. 1, a single or multiple stage device may be provided with a sensor 52, such as an encoder, which cooperates with a coded ring 53 between the outer thrust/stability bearings 40 with an inner diameter which has a magnetic or optically readable surface. The coded ring 43 is read by sensor 52 which is threaded (or inserted by other means) into the bore in the ring 55 which separates the inner races 54 of the thrust/stability races. The sensor 52 in an embodiment may be an optical sensor. In another embodiment, the sensor 52 may be a magnetic sensor. For MRI applications, the sensor may be a lens with a fiberoptic cable going back outside of the MRI zone. An array of pick-up heads can be used for higher resolution. Many other configurations are conceivable. A sensor 89, as shown for example in FIG. 5, designed using the same principles as the sensor 52, may also be located on the input as well as on the output. The output ratio changes with torque due to the actual pivot point drifting around within the contact patch slightly. To track the actual output speed, the encoder should be located on the output. Greater resolution may be achieved by using an encoder on the input or on the motor drive for the input and using the input encoder readings to measure movements within the discernable resolution of the output encoder. In this case the output readout is also used to calibrate the input encoder to the instantaneous ratio which is being transferred by the power transfer device based on the last two points which were read by the output encoder. Other sensors can be used, such as measurement of torque and speed and acceleration with appropriate sensors, which can be used to predict the change in output ratio.

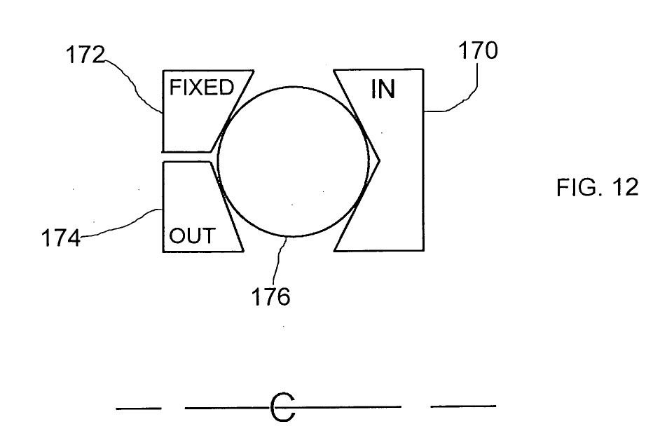

FIG. 12 shows a further embodiment of a friction gear. In FIG. 12, there is shown an input or drive race 170, an output comprising a driven race 174, a reference race 172 and a set of ball elements in contact with each race. The races are supported by a housing (not shown) for axial and radial stability of the races. The races are annular and the ball elements are distributed around the races as with the other embodiments. In this case, the drive race 170 establishes a rotational axis of each of the ball elements 176 and is on an opposite side of the ball elements to the fixed race 172. The rotational axis of the ball elements 176 is parallel to the contact points of the drive race 170, and perpendicular to the axis C about which the races rotate. As with the other embodiments, the output may be driven to form an input, in which case the input becomes the output. Location of the output race 174 in the embodiment shown in relation to the fixed race 172 establishes the gear ratio of this friction gear.

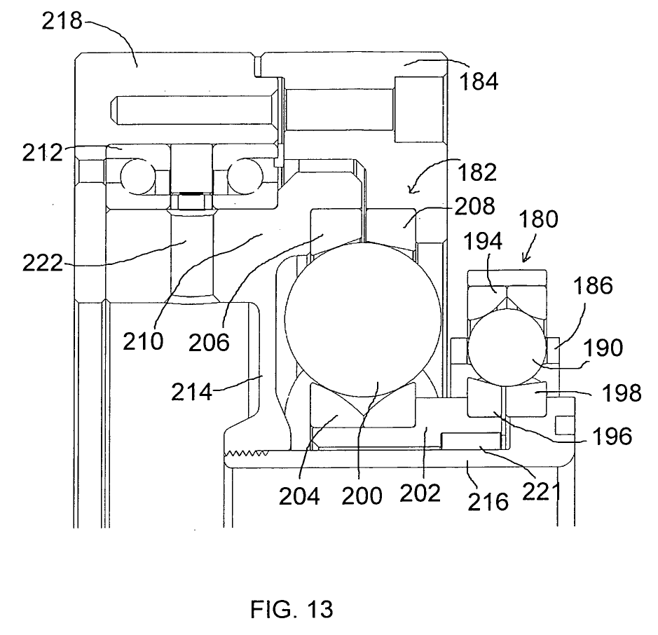

FIG. 13 shows an embodiment of a two stage friction gear configured as a speed reducer using the differential ball principle with on the right side a first stage friction gear 180 and on the left side a second stage friction gear 182 supported by a housing 184. The housing 184 provides axial and radial stability to the friction gear components and may be made of several parts depending on the configuration of the friction gears. This device may be part of three or more stages. In the friction gear 180, a cage 186 holds a set of ball elements 190. The ball elements 190 are supported within races 194, 196 and 198. The ball elements 190 are in contact with the drive race 194 at a set of drive race contacts, with the driven race 196 at a set of driven race contacts, and with the reference race 198 at a set of reference race contacts. The drive race 194 has a pair of contacts on each ball 190 and so establishes the rotational axis of the ball elements 190. As shown in FIG. 13, the drive race 194 has a pair of surfaces that are convex, so that the contact with the ball elements 190 is as shown in FIG. 4. This provides a small contact area, reducing the amount of swirl. The angle of the contact, ie the angle of the tangent of the ball elements 190 and the convex race 194 is in this case about 30 degrees to the rotational axis of the ball elements 190. A larger angle on the first stage ball elements provides greater stability, and less wobble, of the ball elements 190 as they rotate around the races.

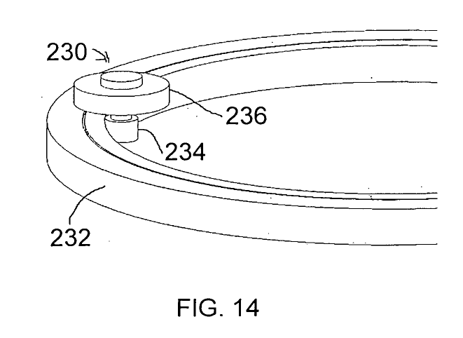

As shown in FIG. 13, the driven race 196 of the gear 180 is connected to an output 202, which forms the input of gear 182. Output 202 is connected to a drive race 204 which is in contact with a set of ball elements 200 of the gear 182. The ball elements 200 are supported within the races 204, 206 and 208. The ball elements 200 are in contact with the drive race 204 at a set of drive race contacts, with the driven race 206 at a set of driven race contacts, and with the reference race 208 at a set of reference race contacts. The contacts of the drive race 204 contact each ball element 200 at two points, and the faces of the drive race 204 at the contacts are convex, as shown in FIG. 4. The angle of the contacts of the drive race 204 on the ball elements 200 in one embodiment is 27.5 degrees, that is, smaller than the contacts of the drive race 194 on the ball elements 190. The driven race 206 is connected to an output 210. The output 210 is stabilized axially and radially by a thrust bearing 212 secured within housing member 218, which is itself secured to housing 184. The thrust bearing 212 may be for example designed as the same manner as the thrust bearing 212 in FIG. 1. The output 210 is also connected to the reference race 198 through a diaphragm spring 214, which is threaded to an extension member 216 that holds the reference race 28. The output 202 may or may not be centered by a bushing 221 on extension member 216. The output of the second stage friction gear 12 in one embodiment is provided with a position encoder 222. Since in each of the friction gears 180 and 182 the respective drive races provided stability to the ball elements 190 and 200, the respective reference and driven races of the friction gears 180, 182 need not have such steep angular contacts, and may be less than 30 degrees and 27.5 degrees respectively. A further embodiment is illustrated schematically in FIG. 14. In FIG. 14, a drive 230 drives a member 232 through gear 234. The member 232 may be a full circle for full rotational movement, or less than a full circle for circular rocking motion and could be straight rather than curved as shown. The configuration of FIG. 14 may function as an azimuth or elevation drive on a telescope. Member 230 may incorporate a single stage or two stage friction gear 236, which drives pinion gear 234. Gear 234 drives member 232 which may be a ring gear rotating inside a slew ring of a device. Member 232 may also be a large single stage or two stage friction gear. Member 230 may also be a standard gear. The pinion gear 234 may also be on the inside or outside or may be replaced by a friction connection or belt drive instead of the pinion gear 234.

Immaterial modifications may be made to the embodiments of the invention described here without departing from the invention.

It will be appreciated that there is more than one invention described in this patent document, and thus where there is a reference to the invention, it will be understood that a particular one of the inventions may be referred to.”

1. A power transfer device, comprising a first stage friction gear and a second stage friction gear supported by a housing for axial and radial stability, each friction gear comprising:
an input comprising a drive race;
a set of ball elements in contact with the drive race at a set of drive race contacts, the ball elements being distributed around the drive race;
a reference race in contact with the ball elements at a set of reference race contacts;
an output comprising a driven race, the driven race being in contact with the ball elements at a set of driven race contacts;
one of the drive race and the driven race establishing a rotational axis of each of the ball elements and being located on an opposite side of the ball elements to the reference race; and
the output of the first stage friction gear being the input of the second stage friction gear.

2. The power transfer device of claim 1 in which the output of the second stage friction gear is stabilized axially and radially by a thrust bearing secured within the housing.

3. The power transfer device of claim 2 in which contacts of least one race of the drive races, reference races and driven races make an angle to the rotational axes of the respective contacted ball elements that is less than or equal to 27.5 degrees.

4. The power transfer device of claim 3 in which the contacts of each of the drive races, reference races and driven races make an angle to the rotational axes of the respective contacted ball elements that is less than or equal to 20 degrees.

5. The power transfer device of claim 1 in which at least one of the drive races, reference races and driven races is convex at its contacts.

6. The power transfer device of claim 1 in which a central opening passes through the drive races, reference races and driven races.

7. The power transfer device of claim 1 in which there are at least seven ball elements in the first stage friction gear.

8. The power transfer device of claim 1 in which there are at least seven ball elements in the second stage friction gear.

9. The power transfer device of claim 1 in which at least one of the drive races, driven races and reference races has a coefficient of static friction with the ball elements when lubricated that is higher than 0.11.

10. The power transfer device of claim 1 in which at least one of the drive races, driven races, reference races and the ball elements has a stiffness greater than 190 GPa.

11. The power transfer device of claim 1 at least partly made of materials that are MRI compatible.

12. The power transfer device of claim 1 partially made of materials that are MRI invisible.

13. The power transfer device of claim 1 in which at least one of the sets of ball elements is lubrication free.

14. The power transfer device of claim 1 in which at least one of the sets of ball elements is lubricated with traction lubricant.

15. The power transfer device of claim 1 in which the output of the second stage friction gear is provided with an output ratio sensor.

16. The power transfer device of claim 1 in which the output of the second stage friction gear is provided with an output position sensor.

17. The power transfer device of claim 1 in which the input of the first stage friction gear is driven by an inner drive.

18. The power transfer device of claim 1 in which the input of the first stage friction gear is driven by an outer drive.

19. The power transfer device of claim 1 in which the reference race of the first stage friction gear is coupled to the driven race of the second stage friction gear.

20. The power transfer device of claim 19 in which the reference race of the first stage friction gear is coupled to the driven race of the second stage friction gear by an axially movable spring member.

21. A power transfer device, comprising:
an input comprising a drive race, an output comprising a driven race, and a reference race supported by a housing for axial and radial stability;
a set of ball elements in contact with the drive race at a set of drive race contacts, the ball elements being distributed around the drive race;
the reference race being in contact with the ball elements at a set of reference race contacts;
the driven race being in contact with the ball elements at a set of driven race contacts;
one of the drive race and the driven race establishing a rotational axis of each of the ball elements and being on an opposite side of the ball elements to the reference race;
the output being stabilized axially and radially by a thrust bearing secured within the housing; and
the thrust bearing securing the output for rotation within the housing.

22-25. (canceled)

26. A power transfer device, comprising:
an input comprising a drive race, an output comprising a driven race, and a reference race supported by a housing for axial and radial stability;
a set of ball elements in contact with the drive race at a set of drive race contacts, the ball elements being distributed around the drive race;
the reference race being in contact with the ball elements at a set of reference race contacts;
the driven race being in contact with the ball elements at a set of driven race contacts;
one of the drive race and the driven race establishing a rotational axis of each of the ball elements and being on an opposite side of the ball elements to the reference race; and
a central opening passing between the drive races, reference races and driven races.

27-28. (canceled)

29. A power transfer device, comprising:
an input comprising a drive race, an output comprising a driven race, and a reference race supported by a housing for axial and radial stability;
a set of ball elements in contact with the drive race at a set of drive race contacts, the ball elements being distributed around the drive race;
the reference race being in contact with the ball elements at a set of reference race contacts;
the driven race being in contact with the ball elements at a set of driven race contacts;
one of the drive race and the driven race establishing a rotational axis of each of the ball elements and being on an opposite side of the ball elements to the reference race; and
at least one of the drive races, driven races and reference races having a coefficient of static friction with the ball elements when lubricated that is higher than 0.11.

30. A power transfer device, comprising:
an input comprising a drive race, an output comprising a driven race, and a reference race supported by a housing for axial and radial stability;
a set of ball elements in contact with the drive race at a set of drive race contacts, the ball elements being distributed around the drive race;
the reference race being in contact with the ball elements at a set of reference race contacts;
the driven race being in contact with the ball elements at a set of driven race contacts;
one of the drive race and the driven race establishing a rotational axis of each of the ball elements and being on an opposite side of the ball elements to the reference race; and
at least one of the drive races, driven races, reference races and the ball elements having a stiffness greater than 190 GPa.

31-35. (canceled)

36. A power transfer device, comprising:
an input comprising a drive race, an output comprising a driven race, and a reference race supported by a housing for axial and radial stability;
a set of ball elements in contact with the drive race at a set of drive race contacts, the ball elements being distributed around the drive race;
the reference race being in contact with the ball elements at a set of reference race contacts;
the driven race being in contact with the ball elements at a set of driven race contacts;
one of the drive race and the driven race establishing a rotational axis of each of the ball elements and being on an opposite side of the ball elements to the reference race; and
the output is provided with a position sensor.

37. (canceled)

38. The power transfer device of claim 1 in which the rotational axes of the ball elements are perpendicular to the axis about which the races rotate.

39. The power transfer device of claim 1 in which the rotational axes of the ball elements are parallel to the axis about which the races rotate.

40. The power transfer device of claim 1 configured as a speed reducer.

41. The power transfer device of claim 1 configured as a speed enhancer.

42. The power transfer device of claim 1 in which at least one of the races and ball elements is made of or coated with tungsten carbide, silicon nitride, silicon carbide, cerbide or nickel.
